(19) United States
(12) Patent Application Publication
(10) Pub. No.: US 2025/0156155 A1
(43) Pub. Date: May 15, 2025

(54) AUTOMATIC MODULE FOR GENERATING SOURCE CODE FOR A MASTER DATA MANAGEMENT APPLICATION

(71) Applicant: BULL SAS, Les Clayes-sous-Bois (FR)

(72) Inventors: Etienne ROUX, Toulouse (FR); JOSUE GOURVELLEC, Toulouse (FR); Omar BERRADA, Beaucouzé (FR)

(73) Assignee: BULL SAS, Les Clayes-sous-Bois (FR)

(21) Appl. No.: 18/947,462

(22) Filed: Nov. 14, 2024

(30) Foreign Application Priority Data
Nov. 15, 2023 (EP) 23306979.8

(51) Int. Cl. G06F 8/30

(52) U.S. Cl. CPC G06F 8/30

(57) ABSTRACT

The invention relates to a method, implemented by a computer, of generating a source code that is read by a master data management application. The method includes converting a master data set into a formatted data set according to a set of conversion rules, and transcribing, according to a set of transcription rules, the formatted data set into the source code that is read by the master data management application.

This application claims priority to European Patent Application Number 23306979.8 filed 15 Nov. 2023, the specification of which is hereby incorporated herein by reference.

### BACKGROUND OF THE INVENTION

### Field of the Invention

The technical field of the invention is that of Master Data Management (MDM).

At least one embodiment of the invention relates to a method of generating source code that can be read by a master data management application, a method of generating a master data set from source code that can be read by a master data management application, and a method of transferring a source code that can be read by a first data management application to a second data management application.

### Description of the Related Art

There are a large number of applications dedicated to Master Data Management (MDM). These applications are published according to particular specificities, which means that there is no homogeneity between the different source codes that can be read by said applications. In other words, there is no solution for transposing a source code of a model defined for a given application into a source code of this model that can be read by another master data management application. Furthermore, the specificities of each MDM application mean that it is not easy for a user, wishing to implement a master data management strategy, to deploy an existing model or a new model using an application that they do not know how to use. In other words, implementing an MDM strategy requires the user to have an advanced command of the application in question.

At least one embodiment of the invention described below therefore offers a solution to the above-mentioned problems.

### BRIEF SUMMARY OF THE INVENTION

At least one embodiment of the invention offers a solution to the above-mentioned problems, by proposing an automatic module for converting master data into source code, source code into master data, and source code into other source code.

At least one embodiment of the invention relates to a method, implemented by a computer, of generating source code that can be read by a master data management application, the method comprising:
Converting a master data set into a formatted data set according to a set of conversion rules,
Transcribing, according to a set of transcription rules, the formatted data set into source code that can be read by the master data management application.

A Master Data Management (MDM) application is a set of concepts, processes and tools for defining, storing, maintaining, distributing and enforcing a complete, reliable and up-to-date view, a so-called “model”, of master data within an information system. The model thus established is independent of the communication media, business sector or professional or geographical subdivisions of an organization for which this model is defined.

Reference data, also known as referential data or master data, is understood to mean data that is common to the information processes that support the day-to-day activities of an organization, for example for decision-making. By way of example, the master data may comprise a definition of the model in the business sense, one or more rules for checking the consistency and the quality of the information as well as specifications concerning the data flow itself, also known as an interface contract, defining the rules for exchanging data between two interfaces.

“Source code generation” is understood to mean writing source code in digital form onto a permanent data medium such as a file that can be saved on a memory of a computer system, for example a memory of a computer, a server, a cloud system or a memory of a mobile storage medium, such as a USB (Universal Serial Bus) key or a hard disk. The file is, for example, in a format that may contain characters and may be transferred from one memory medium to another. The format of the file can be read and interpreted by said application to implement the source code contained in this file and implement the model described therein.

Source code is understood to be “readable” by an MDM application when said source code can be interpreted as source code by the MDM application and can be implemented and deployed by the application simply by reading said code.

“Formatted data set” is understood to mean that the master data set is converted into a data set whose writing structure is formatted, that is, imposed and defined, by the set of conversion rules. The set of conversion rules therefore defines the writing formalism in which to format the master data set. The master data set must therefore be written according to a predefined format compatible with the set of conversion rules.

“Transcription rules” are understood to be rules that indicate how to transcribe the formatted data set into source code that can be read by the application concerned. The set of transcription rules is therefore associated with a single MDM application, that is, for another desired MDM application, another set of transcription rules is used to produce the source code that can be read by this other application.

By virtue of one or more embodiments of the invention, it is possible to automatically convert the master data set into source code that can be read by the master data management application. This conversion is transparent to the user, who does not need to be an expert in said application in order to use it. In this way, the deployment of a new master data management model, populated via the master data set, is easily implemented automatically by the method. In other words, the method according to at least one embodiment of the invention serves as an interface for transposing the master data set into source code that can be read by the desired master data management application, independently of the application in question, by virtue of using the formatted data set, notably via the conversion and transcription thereof.

Furthermore, by virtue of one or more embodiments of the invention, the master data set may be presented in a “business” format, that is, in a format that requires no special programming skills and is close to everyday language.

Advantageously, in at least one embodiment, it is possible to use the method for development purposes in order to evaluate the sensitivity of a model to a change in the master data set. In other words, it is possible to easily implement one or more variants of an MDM model, via the same or different MDM applications, and to evaluate the effect of implementing each variant on the implemented model. Converting to a formatted data set makes it easy to produce these variants from the master data set and to transcribe them into source code for each MDM application concerned, without having to construct each variant for each application, and without needing the programming skills required to design the source codes.

The method according to one or more embodiments therefore improves the user's control over the MDM model(s) he wishes to implement, which he can then easily adapt to his needs.

In addition to the features just mentioned, the method according to at least one embodiment of the invention may have one or more complementary features from the following, taken individually or according to all technically plausible combinations.

In at least one embodiment, the method further comprises transmitting the source code to the master data management application.

This thus allows the generated source code to be automatically transmitted to the data management application so that, for example, it can implement the model defined therein.

In at least one embodiment, the method comprises:
Detecting an inconsistency in the master data set by comparison with a set of check rules and/or a previous master data set, and wherein conversion and transcription are implemented when no inconsistencies in the master data set are detected.

“Inconsistency” is understood to mean an anomaly in the form or content of the data in the master data set. This anomaly may result from one or more items of data being missing, poorly defined and/or in a format and/or a structure incompatible with the predefined format. A master data set with an inconsistency would therefore not be compatible with the conversion rules. For example, an anomaly may be the absence of postal codes in a list of addresses, or the writing in alphabetical format of digits expected in numerical format.

“Check rules” is understood to mean rules specifying the necessary data that must be contained in the master data set to construct the formatted data set in order to construct the model for the MDM application.

“Previous master data set” is understood to mean a previously established master data set that is compatible with the conversion rules.

It is thus possible to detect an error in the master data at an early stage so that conversion is not carried out on the basis of incomplete or erroneous master data.

In other words, the method according to one or more embodiments allows consistency check rules to be passed over the master data set in order to verify that the modeling is described correctly in this data. In particular, the check rules are used to verify that the structure of the master data set conforms to one or more construction rules, that the model is functional, that is, it can be read and interpreted without error, and that the model conforms to the interface contract. This therefore ensures that the formatted data set correctly describes the model so that it can be transcribed into source code.

In at least one embodiment, the method further comprises:
Issuing a warning about the detected inconsistency.

It is thus possible to inform the user so that the master data set is modified prior to conversion of the master data set.

At least one embodiment of the invention relates to a method, implemented by a computer, of generating a master data set from source code that can be read by a master data management application, the method comprising:
Transcribing, according to a set of back-transcription rules, the source code into a formatted data set,
Converting the formatted data set into the master data set according to a set of back-conversion rules.

By virtue of this method, in one or more embodiments, it is possible to implement the reverse mechanism of the method according to at least one embodiment, that is, it is possible, for example for documentation, archiving, analysis or modification purposes, to produce the master data set from the source code that describes the model.

In at least one embodiment, the method comprises:
Detecting an inconsistency in the master data set by comparison with a set of check rules and/or a previous master data set.

It is thus possible to detect an error in the master data, for example due to a malfunction in generating the master data set and/or due to an anomaly in the model describing the source code.

In at least one embodiment, the method further comprises:
Issuing a warning about the detected inconsistency.

In this way, the user can be informed of the presence of an inconsistency.

At least one embodiment of the invention relates to a method, implemented by a computer, of transferring a first source code, that can be read by a first data management application, into a second source code that can be read by a second data management application, the method comprising:
Transcribing, according to a set of back-transcription rules, the first source code into a formatted data set;
Transcribing, according to a set of transcription rules, the formatted data set into the second source code.

By virtue of this method, in one or more embodiments, it is possible to combine the methods according to at least one embodiment in order to transcribe source code for implementing a model in a first MDM application to a second MDM application, by generating the master data set from the source code that can be read by the first application, and then generating source code that can be read by the second application from this master data set.

In at least one embodiment of the method, the first source code is back-transcribed into a first formatted data set, and comprising:
Converting the first formatted data set into a master data set according to a set of back-conversion rules;
Converting the master data set into a second formatted data set according to a set of conversion rules, the second source code being transcribed from the second formatted data set.

In this way, in one or more embodiments, it is possible to benefit from the conversion of the model into a master data set in order to allow the user to easily check and/or modify this model. This also allows the model to be retained, for example for archiving or documentation purposes, or for generating source code that can be read by another MDM application.

In at least one embodiment, the method comprises:
Detecting an inconsistency in the master data set by comparison with a set of check rules and/or a previous master data set;
   and wherein conversion of the master data set to the second formatted data set is implemented when no inconsistencies in the master data set are detected.

It is thus possible to detect an error in the master data at an early stage so that conversion is not carried out on the basis of incomplete or erroneous master data.

In at least one embodiment, the method further comprises:
Issuing a warning about the detected inconsistency.

It is thus possible to inform the user so that the master data set is modified prior to conversion of the master data set.

In at least one embodiment of the method, the master data set is constructed in accordance with at least one construction rule.

The construction rule defines the format in which the master data set must be written in order to be compatible with the set of conversion rules.

In at least one embodiment of the method:
The master data set is included in a file that is in a spreadsheet type format constructed according to the at least one construction rule;
The formatted data set is contained in a file in a generic markup type format;
The set of transcription and/or back-transcription rules is contained in a file established in a functional type transformation language.

In at least one embodiment of the method, the file comprising the master data set is in XLS or XLSX format, the file comprising the formatted data set is in XML format, and the file comprising the set of transcription and/or back-transcription rules is in XSLT format.

The files used are therefore in well-known easy-to-use formats, making them versatile to use and compatible with MDM methods on the market.

At least one embodiment of the invention relates to a computer system configured to implement a method according to the one or more embodiments.

At least one embodiment of the invention relates to a computer program product comprising instructions which, when the software is executed by a computer, enable the latter to implement the steps of the method according to the one or more embodiments.

At least one embodiment of the invention relates to a computer-readable recording medium comprising instructions that, when executed by a computer, make the latter implement the steps of the method according to the one or more embodiments.

The one or more embodiments of the invention and its different applications will be better understood upon reading the following description and examining the accompanying figures.

### BRIEF DESCRIPTION OF THE DRAWINGS

The figures are presented by way of reference and are in no way limiting to the invention.

FIG. 1 is a block diagram showing the sequence of steps in a method of generating source code, according to one or more embodiments of the invention.

FIG. 2 is a schematic representation showing source code generation, according to one or more embodiments of the invention.

FIG. 3 is a block diagram showing the sequence of steps in a method of generating a master data set, according to one or more embodiments of the invention.

FIG. 4 is a schematic representation showing the generation of a master data set, according to one or more embodiments of the invention.

FIG. 5 is a block diagram showing the sequence of steps in a method of transferring one source code into another source code, according to one or more embodiments of the invention.

FIG. 6 is a schematic representation showing the transfer of one source code into another source code, according to one or more embodiments of the invention.

FIG. 7 is a schematic representation of a system for implementing a method, according to one or more embodiments of the invention.

FIG. 8 is a schematic representation of source code generation and master data set generation, according to one or more embodiments of the invention.

### DETAILED DESCRIPTION OF THE INVENTION

Unless otherwise stated, the same element appearing in different figures has the same reference.

As presented below, at least one embodiment of the invention relates to a set of mechanisms for generating source code that can be read by a master data management (MDM) application, for generating a master data set, and for transferring source code to source code that can be read by another MDM application.

These different mechanisms can be implemented independently by a single module, hereinafter referred to as an “automatic module”. this automatic module is described in more detail later.

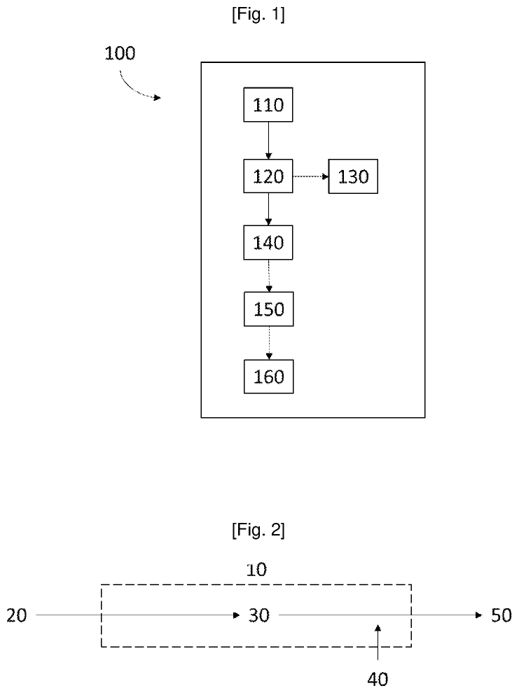

At least one embodiment of the invention therefore relates to a method 100 of generating source code that can be read by a master data management application, as shown in FIG. 1. This method 100 can be implemented by the automatic module.

As shown in FIG. 2, in one or more embodiments, this method 100 generates source code 50 by supplying a master data set 20 to the automatic module 10, which first converts the master data set 20 into a formatted data set 30, then converts the latter into source code 50 based on a set of transcription rules 40.

The master data set 20 is, for example, predefined automatically or by a user, according to at least one construction rule, that is, that this set is preconfigured in accordance with the construction rule. This construction rule is pre-established so that the master data set 20 is constructed according to a known and expected format, in order to be automatically converted into the formatted data set 30 by the automatic module 10. The master data set 20 comprises and/or describes the model to be implemented by the MDM application.

The method 100 may comprise a step 110 of obtaining the master data set.

The method 100 comprises a step 140 of converting the master data set 20 into the formatted data set 30. This conversion is implemented by respecting conversion rules included in a set of conversion rules. These conversion rules indicate how to transform the master data set 20 into the formatted data set 30. For example, these conversion rules indicate how to transform the master data set constructed according to a specific format defined by the construction rule, for example a specifically predefined format to allow rapid conversion of the master data set into a generic format independent of the model, for the intended use of the model and the MDM application in question. The advantage of such a formatted data set 30 is that it provides a definition of the desired model in a generic format that can subsequently be converted into any source code for an MDM application.

The method 100 also comprises a step 150 of transcribing the formatted data set 30 into source code 50 that can be read by the MDM application. Transcription is carried out by applying the rules from a set 40 of transcription rules, which indicate how to produce source code 50 from the formatted data set 30. The set 40 of transcription rules is therefore associated with the MDM application in question, that is, that in the event of transcription to another MDM application, another set of transcription rules is used to generate the related source code 50. This other set 40 of transcription rules may be similar to or different from the set 40 of transcription rules.

The method 100 may also comprise a step 160 of transmitting source code that can be read by the MDM application in question to said MDM application. This application will then have the source code 5 to implement in order to implement the model as defined by the master data set 20.

In at least one embodiment, the method 100 comprises a step 120 of detecting an inconsistency in the master data set 20. The inconsistency is detected, for example, by comparing the set 20 of master data with a set of check rules. This set of check rules defines an expected format and/or content of the set 20 of master data so that conversion can be performed. If there is any inconsistency, then the conversion cannot be implemented.

Alternatively or in conjunction, by way of one or more embodiments, the inconsistency can be detected by comparing the master data set 20 with a previous master data set 20. The structure, format and content of the two master data sets 20 can thus be compared in order to detect differences between these two sets. When the difference relates to an element that must satisfy the check rules, an inconsistency is detected.

The inconsistency is therefore detected between the master data set and the set of check rules and/or the previous master data set.

The method 100, in at least one embodiment, may then comprise a step 130 of issuing a warning about the detected inconsistency. The warning is used to inform the user that an inconsistency is detected in the master data set 20. The warning comprises, for example, information indicating the presence of an inconsistency, for example in the form of an error message comprising alphanumeric characters. The warning may also comprise information to indicate the location and/or nature of the inconsistency in the master data set 20. The user can then take action to correct the master data set 20.

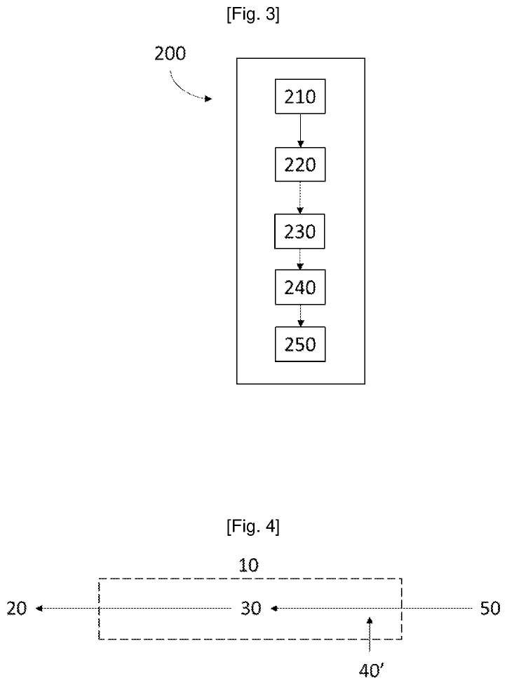

Furthermore, at least one embodiment of the invention relates to a method 200 of generating a master data set 20, as shown in FIG. 3. This method 200 may be implemented by the automatic module.

As shown in FIG. 4, by way of one or more embodiments, this method 200 generates a master data set 20 by supplying a source code 50 to the automatic module 10, which first converts the source code 50 into a formatted data set 30 based on a set 40′ of back-transcription rules, and then converts the formatted data set 30 into the master data set 20.

The method 200 may comprise a step 210 of obtaining source code 50, which can be read by an MDM management application. The source code 50 has previously been established and defines a data management model so that the implementation thereof by the MDM application allows this model to be implemented.

The method 200 comprises a step 220 of transcribing source code 50 that can be read by the MDM application into the formatted data set 30. Transcription is carried out by applying the rules of the set 40′ of back-transcription rules, which indicate how to produce the formatted data set 30 from the source code 50. The set 40′ of back-transcription rules is therefore associated with the MDM application in question, that is, if a source code 50 that can be read by another MDM application is transcribed, another set 40′ of back-transcription rules is used to generate the related formatted data set 30. This other set 40′ of back-transcription rules may be similar to or different from the set 40′ of back-transcription rules.

The back-transcription rules are, for example, the inverse, or reciprocal, rules of the transcription rules used by the implementation of the method 100, associated with the same MDM application.

The method 200 also comprises a step 230 of converting the formatted data set 30 into the master data set 20. This conversion is implemented by respecting back-conversion rules included in a set of back-conversion rules. These back-conversion rules indicate how to transform the formatted data set 30 into the master data set 20. For example, these conversion rules indicate how to transform the formatted data set 30 constructed according to a generic format, independent of the model, for the intended use of the model and the MDM application in question, into a specific format. The advantage of constructing such a master data set 20 is that it provides a definition of the desired model in a form that can be understood and manipulated by a user without requiring advanced command of the MDM application from which the model originates.

The back-conversion rules are, for example, the inverse rules of the conversion rules used to implement the method 100.

The master data set 20 is, for example, automatically constructed according to at least one construction rule, such as the construction rule mentioned above, in the case of the method 100.

This method also extracts the metadata contained in the source code and which is specific to the MDM application in which the source code is implemented. This metadata is therefore also back-converted and included in the constructed master data set.

In at least one embodiment, the method 200 comprises a step 240 of detecting an inconsistency in the master data set 20 constructed in the previous step 230. This step 240 of detecting an inconsistency is implemented in the same way as the step 120 of detecting an inconsistency in the method 100.

The method 200 may then comprise a step 250 of issuing a warning about the inconsistency detected in the previous detection step 240. This step 250 of issuing a warning is implemented in the same way as the step 130 of issuing a warning for the method 100.

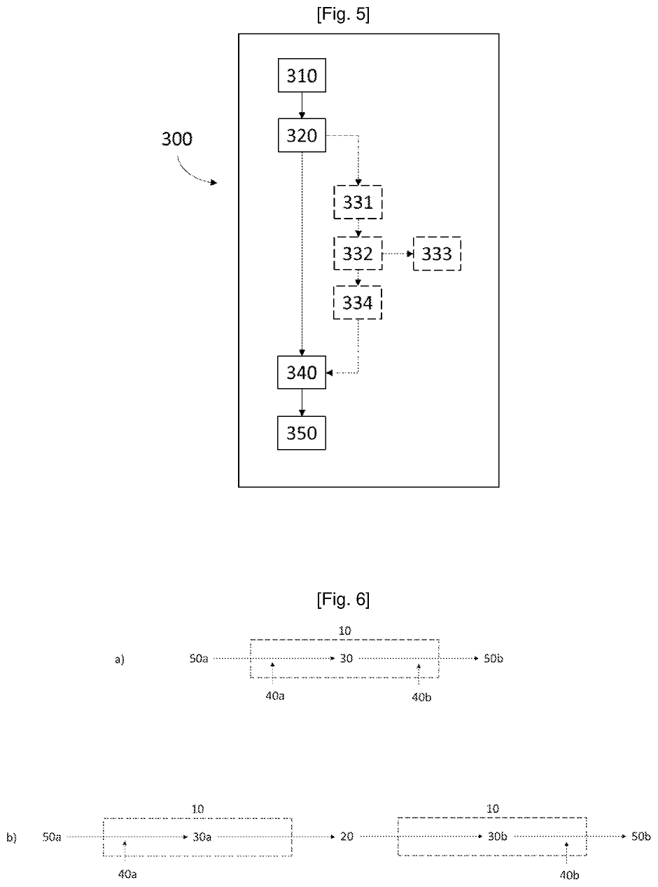

At least one embodiment of the invention also relates to a method 300 of transferring source code, as shown in FIG. 5. The transfer transforms source code that can be read by a first MDM application into source code that can be read by a second MDM application. This therefore involves transferring source code that can be read by the first application to the second application. In other words, this method 300 migrates the model implemented by the first application to the second application, so that the latter can implement it. This method 300 can be implemented by the automatic module.

As shown in FIG. 6, by way of one or more embodiments, this method 300 generates a second source code 50b, that can be read by the second application, by supplying a first source code 50a, that can be read by the first application. There are two possible ways of making this transfer:
In the first variant, by way of one or more embodiments, shown in FIG. 6a, the first source code 50a is supplied to the automatic module 10, which transcribes this first source code 50a into a formatted data set 30 based on a set 40a of back-transcription rules. The formatted data set 30 is then transcribed into the second source code 50b based on a set 40b of transcription rules,
In the second variant, by way of one or more embodiments, shown in FIG. 6b, the first source code 50a is supplied to the automatic module 10, which transcribes this first source code 50a into a first formatted set 30 of data based on a set 40a of back-transcription rules, then the automatic module back-converts the first formatted data set 30a into a set 20 of master data, in accordance with the set of construction rules. The master data set 20 is then converted by the automatic module 10 into a second formatted data set 30b. This is then transcribed into the second source code 50b based on a set 40b of transcription rules. In other words, this second variant is equivalent to implementing the method 200, starting from the first source code 50a, and then implementing the method 100, in order to generate the second source code 50b from the set of product master data generated by implementing the method 200.

The advantage of the first variant is that the source code can be automatically transferred to the second application, limiting the number of intermediate operations and the risk of errors due to successive conversions and back-conversions. The advantage of the second variant is that it allows a user to modify or control the model by modifying the master data set 20, which does not require advanced command of the first and second MDM applications in order to be able to modify the model.

The method 300 may comprise a step 310 of obtaining the first source code 50a. The first source code 50a is established prior to implementing the method 300 and defines a data management model so that the implementation thereof by the first application allows this model to be implemented.

The method 300 comprises a step 320 of transcribing the first source code 50a that can be read by the first MDM application into the formatted data set 30. This transcription step 320 is implemented in a similar way to the transcription step 220 of the method 200. The set of back-transcription rules is herein associated with the first MDM application.

The method 300 also comprises a step 340 of transcribing the formatted data set 30 into the second source code 50b. This transcription step 340 is implemented in a similar way to the transcription step 150 of the method 100. The set of transcription rules is herein associated with the second MDM application and is therefore different from the set of back-transcription rules used in the previous step 320.

The method 300 may also comprise a step 350 of transmitting the second source code 50b to the second MDM application. This transmission step 350 is implemented in a similar way to the transmission step 160 of the method 100.

The step 310 of obtaining the first source code 50a, the step 320 of transcribing the first source code 50a, the step 340 of transcribing into the second source code 50b and the step 350 of transmitting the second source code 50b are common to both variants of this method 300.

According to the second variant, in at least one embodiment, the method 300 comprises the above-mentioned steps and the additional steps between the step 320 of transcribing the first source code 50a and the step 340 of transcribing into the second source code 50b. These additional steps correspond to the conversion and back-conversion steps of the master data set.

Furthermore, in this variant, the formatted data set 30 back-transcribed from the first source code 50a is referred to as the first formatted data set 30a.

Thus, the method 300 according to the second variant further comprises a step 331 of converting the first formatted data set 30 into the master data set 20, by way of at least one embodiment. This conversion is implemented in a similar way to the implementation of the conversion step 230 of the method 200. The user can thus access the master data of the model in order to analyze, verify and/or, if necessary, modify the data before converting it to the second MDM application.

The method 300 according to the second variant, in at least one embodiment, also comprises a step 334 of converting the master data set 20 into a second formatted data set 30b. It is this second formatted data set 30b that is subsequently used in step 340 of transcribing the formatted data set 30 into the second source code 50b.

Moreover, in this second alternative, in one or more embodiments, the method 300 may comprise a step 332 of detecting an inconsistency in the master data set 20. This inconsistency detection step 332 is implemented in a similar way to step 120 of the method 100. This step determines whether an error has occurred during back-transcription or back-conversion, necessitating modification of the master data set 20 generated in the previous step, or whether a user modification has generated an inconsistency. It is thus possible to apply a correction to the master data set 20 in order to correct this set, or to implement the steps of the method 300 again. A patch may also be implemented to correct the set 40a of back-transcription and/or back-conversion rules, where applicable, that caused the error. Thus, when an inconsistency is detected, the steps of the method 300 used to generate the second source code 50b from the master data set 20 are not implemented, that is, steps 334, 340 and 350.

The method 300 may then comprise a step 333 of issuing a warning about the detected inconsistency. This step can be implemented in a similar way to the step 170 of issuing the warning of the method 100.

In other words, in at least one embodiment, the method 300 according to the second variant is equivalent to:
Generating a master data set from the first source code by implementing the method 200,
Generating the second source code from the master data set, by implementing the method 100.

The set of conversion rules, used in the method 100 and/or the method 300, is established prior to implementing the method 100, for example by approaches known per se. Similarly, the set of back-conversion rules, used in the method 200 and/or the method 300, is established prior to implementing the method 100, for example by approaches known per se.

The set 40 of transcription rules, used in the method 100 and/or the method 300, is established prior to implementing the method 100, for example by approaches known per se. Similarly, the set 40 of back-transcription rules, used in the method 200 and/or the method 300, is established prior to implementing the method 100, for example by approaches known per se.

In some cases, in one or more embodiments, software and hardware developments within an organization mean that the rules for constructing master data are bound to change, for example for reasons of updating, upgrading or patching.

In these cases, in one or more embodiments, it is possible to compare a formatted data set resulting from the conversion of a master data set constructed according to the construction rules modified as a result of these developments, with an already existing formatted data set. Conversion of this data set originating from modified rules is carried out using a set of conversion rules that has also been modified as a result of the developments in question. The existing formatted data set then serves as a reference, and can be obtained by implementing one of the methods 100, 200 or 300.

The purpose of this comparison is to check that the modified construction rules and that the modified conversion rules have been properly established in order to produce a formatted data set, resulting from these modifications, compatible with the transcription into source code.

Thus, when a non-conformity of the formatted data set resulting from these modifications is detected, a warning is issued to inform the operator or user that the modified construction rules and/or modified conversion rules do not conform.

“Compliant” is understood to mean that the formatted data set resulting from the modification is similar in structure and format to the formatted data set used as a reference.

The automatic module is preferentially a software module, that is, a set of computer code configured to implement actions. Consequently, the automatic module is configured to implement the steps of the methods 100, 200 and/or 300 mentioned above. For example, the automatic module comprises instructions which, when implemented by a computer system, for example by a processor included in said computer system, allow method 100, method 200 and/or method 300 to be implemented.

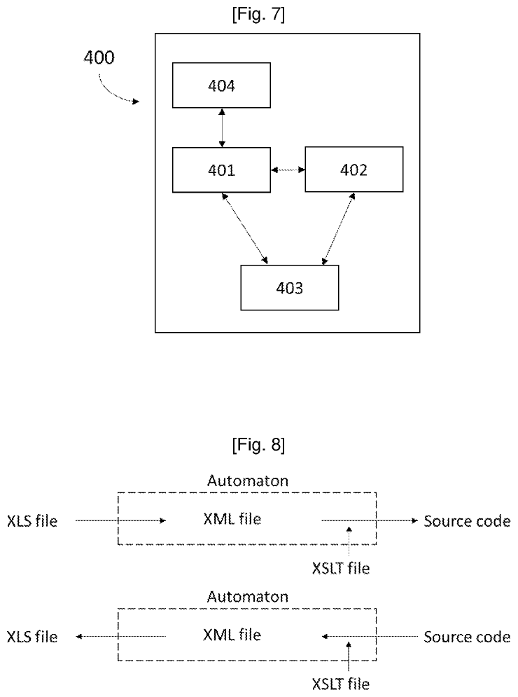

At least one embodiment of the invention therefore relates to the computer system 400 as shown in FIG. 7. This system 400 is therefore configured to implement the automatic module functionalities, that is, methods 100, 200 and/or 300. As such, the system 400 comprises the processor 401 to implement the instructions included in the automatic module. This automatic module may be included in a memory 402 of the system 400, for example a volatile memory or a non-volatile memory. In other words, the system 400 therefore comprises instructions in the memory for implementing one of the above-mentioned methods 100, 200 and/or 300 by executing these instructions via the processor 401.

The system 400 may also comprise a communication module 404, configured to allow the implementation of the obtaining step according to step 110 of method 100, step 210 of method 200 and/or step 310 of method 300, and/or to allow transmission according to step 130 of method 100, step 160 of method 100, step 250 of method 200, step 333 of method 300 and/or step 350 of method 300.

The system 400 may also comprise a display module configured to display the warning, according to step 130 of method 100 and/or step 333 of method 300, and thus inform the user that there is an inconsistency in the master data set.

In at least one embodiment:
The master data set used by method 100, method 200 and/or method 300 is included in a file which is in a spreadsheet type format constructed according to the construction rule, for example a file in XLS or XLSX format;
The formatted data set used by method 100, method 200 and/or method 300 is included in a file that is in a generic markup type format, for example an XML format file;
The set of transcription and/or back-transcription rules are included in a file established in a functional type transformation language, for example a file in XSLT format.

In at least one embodiment, as shown in FIG. 8, the source code is generated by the automatic module as shown in FIG. 8a in one or more embodiments, according to method 100, by converting the content of the XLS or XLSX file, comprising the master data set, into the XML file, comprising the formatted data set, which is then transcribed into source code based on the set of conversion rules included in the XSLT file. Furthermore, in at least one embodiment, the master data set may be constructed by the automatic module as shown in FIG. 8b, according to method 200, by transcribing the source code into the XML file comprising the formatted data set based on the set of back-transcription rules included in the XSLT file, and then converting the XML file into the XSL or XSLX file.

The XML file may be based on list or list-of-list structures, making it adaptable to any type of model, to be transcribed into the source code of any MDM application or back-converted into a master data set.

By way of example, in at least one embodiment, the spreadsheet type file may be structured into several categories, which define the model, each corresponding to a set of attributes to be filled in. These categories may relate, for example, to the internal architecture of the organization wishing to implement the MDM model (list of entities, list of business units, list of members, etc.). Each category may comprise one or more attributes to be filled in, such as a list of the organization's entities, accompanied by an address, entity name, entity address, etc.

Again by way of example, in at least one embodiment, the generic markup type file, to which the spreadsheet type file is converted, can then be in a structure in the form of lists, each corresponding to a category entered in the spreadsheet type file. Each list may also comprise one or more lists. For example, a list may correspond to the organization's entities, in which a list of entities is listed, where each entity is a list of attributes relating to the attributes entered in the table. For example, a list of attributes defined by XML tags.

Again by way of example, in at least one embodiment, the functional type transformation language file comprises instructions, written in the functional format, to explain the implementation of each transcription rule. For example, this file comprises computer functions for browsing the list of categories and browsing each attribute (that is, the tags) in each list or each list of category lists in order to map each attribute content (that is, tag content) to a set of instructions in the source code to be generated. The source code is, for example, generated in EBX® format in order to be implemented by the TIBCO® application. In the case of back-transcription, this file allows the reverse operation, namely to construct the lists of categories and the corresponding attributes, in tag form, in the generic markup type file, from the existing source code.

By way of illustration, in at least one embodiment, the spreadsheet comprises the list of members of the organization, each of whom is assigned an identification number comprising two letters (for the entity to which the member belongs) and a sequence of eight digits. The automatic module then checks that the identification number comprises two letters and eight digits and indicates an inconsistency if this identification number is not in the correct format (for example, because the number of letters or digits does not match the format rule for an identification number). When no inconsistencies are detected, the automatic module converts the list of members and their identification number into a list of tag lists in the generic markup type file. The automatic module then applies the transcription rules described in the functional type transformation language file and which indicate how this information (the list of members and the tag content) must be transcribed in order to be interpreted as being source code content by the desired MDM application. At the end of transcription, the source code is generated by the automatic module.

Conversely, in at least one embodiment, and still by way of illustration, the automatic module back-transcribes the source code into a list of tags (comprising the identification numbers of the list of members) in the generic markup type file based on the transcription rules included in the functional type transformation language file (which may describe the reciprocal or inverse rules to those contained in the transcription rules file). The generic markup type file is converted back to a spreadsheet type file by the automatic module, comprising the list of members and their corresponding identification number attribute in spreadsheet format.

Again by way of illustration, in at least one embodiment, the automatic module may be used to cascade the back-transcription of the source code into a spreadsheet type file then its transcription into another source code, for another MDM application. Alternatively, in at least one embodiment, back-conversion into a spreadsheet type file and conversion of this file into a generic markup type file is not mandatory and the source code can be generated directly from the generic markup type file by applying the transcription rules included in the file in the related functional type transformation language.

1. A method, implemented by a computer, of generating a source code that is read by a master data management application, the method comprising:
converting a master data set into a formatted data set according to a set of conversion rules;
transcribing, according to a set of transcription rules, the formatted data set into the source code that is read by the master data management application.

2. The method according to claim 1, further comprising transmitting the source code to the master data management application.

3. The method, according to claim 1, wherein the source code generated by the transcribing of the formatted data set according to the set of transcription rules is a second source code, the master data management application through which the second source code is read is a second data management application, and wherein the formatted data set is transcribed from a first source code, that is read by a first data management application, according to a set of back-transcription rules.

4. The method according to claim 3, wherein the first source code is back-transcribed into a first formatted data set, and the method further comprises
converting the first formatted data set into the master data set according to a set of back-conversion rules;
converting the master data set into a second formatted data set according to a second set of conversion rules, the second source code being transcribed from the second formatted data set.

5. The method according to claim 1, further comprising
detecting an inconsistency in the master data set by comparison with one or more of a set of check rules and a previous master data set;
and wherein the converting and the transcribing are implemented when no inconsistencies are detected in the master data set.

6. The method according to claim 4, wherein the converting of the master data set into the second formatted data set is implemented when no inconsistencies are detected in the master data set.

7. A method, implemented by a computer, of generating a master data set from source code that is read by a master data management application, the method comprising:
transcribing, according to a set of back-transcription rules, the source code into a formatted data set;
converting the formatted data set into the master data set according to a set of back-conversion rules.

8. The method according to claim 7, further comprising
detecting an inconsistency in the master data set by comparison with one or more of a set of check rules and a previous master data set.

9. The method according to claim 7, wherein the master data set is constructed in accordance with at least one construction rule.

10. The method according to claim 9, wherein,
the master data set is included in a file which is in a spreadsheet type format constructed according to the at least one construction rule;
the formatted data set is included in a file which is in a generic markup type format;
the set of back-transcription rules is contained in a file established in a functional type transformation language.

11. The method according to claim 10, wherein the file comprising the master data set is in XLS or XLSX format, the file comprising the formatted data set is in XML format, and the file comprising the set of back-transcription rules is in XSLT format.

12. The method according to claim 1, wherein the method is implemented by a computer system.

13. A non-transitory computer program product comprising instructions that, when the non-transitory computer program product is executed on a computer, lead the non-transitory computer program product to implement a method of generating a source code that is read by a master data management application, the method comprising:
converting a master data set into a formatted data set according to a set of conversion rules;
transcribing, according to a set of transcription rules, the formatted data set into the source code that is read by the master data management application.

14. A non-transitory computer-readable recording medium comprising instructions that, when executed by a computer, lead the non-transitory computer-readable recording medium to implement a method of generating a source code that is read by a master data management application, the method comprising:
converting a master data set into a formatted data set according to a set of conversion rules;
transcribing, according to a set of transcription rules, the formatted data set into the source code that is read by the master data management application.
